(19) United States
(12) Patent Application Publication
(10) Pub. No.: US 2020/0308910 A1
(43) Pub. Date: Oct. 1, 2020

(54) LOCKING SYSTEM FOR FOLDABLE LADDER

(71) Applicant: Otis Elevator Company, Famington, CT (US)

(72) Inventors: Nicolas Guillot, Coullons (FR); Aurelien Fauconnet, Isdes (FR)

(21) Appl. No.: 16/313,287

(22) PCT Filed: Jun. 26, 2017
(86) PCT No.: PCT/US2017/039184

§ 371 Date: Dec. 26, 2018

(30) Foreign Application Priority Data
Jun. 27, 2016 (EP) 16305773.0

(51) Int. Cl. E06C 1/383; E06C 7/50

(52) U.S. Cl. CPC E06C 1/383; E06C 7/50

(57) ABSTRACT

Foldable ladders and related methods for use within a pit of an elevator system include a first upright, a second upright, and a plurality of rungs pivotally mounted to each of the first upright and the second upright. A locking mechanism has a first segment pivotally attached to the first upright and a second segment pivotally attached to the second upright, and the two segments are pivotally connected. A locking device is located on an upright and operably connected to a segment. The locking device includes a first catch and a second catch, a pin moveable to engage with the first catch in a first position and moveable to engage in a second position. A biasing mechanism applies a force to the pin to engage the pin with a catch. An operating device is operable to apply opposing force against the biasing mechanism to disengage the pin from the catch.

### BACKGROUND

The subject matter disclosed herein generally relates to ladders for accessing the pit of an elevator system and, more particularly, to locking systems for foldable ladders used to access the pit of an elevator system.

Elevator systems may require maintenance and/or other operations to be performed by technicians or other personnel (e.g., maintenance, inspection, repair, etc.). Some of such operations must be performed within the shaft of the elevator, and particularly, some operations are performed within a pit of the elevator. Accordingly, elevator systems are equipped with a ladder to access to the pit. The ladder has a length up to 3.3 m. In many cases the ladder must be foldable to save space within the elevator shaft and/or pit especially in small-configuration hoistways (e.g., reduced width elevator shaft). Foldable ladders can be equipped with locking systems to ensure the folded or unfolded positions are maintained during use. The ladder locking system must be accessible from the landing (for pit access and egress) and also from the pit so that the ladder can be stored and/or collapsed to prevent the ladder from being in the way of the technician. Further, the ladder must be collapsible so that an elevator car can move within the elevator shaft by operation of a pit control station. However, traditional elevator pit ladders are too large for small-configuration hoistways having decreased width and depth as compared to traditional sized elevators/elevator shafts. Accordingly, with traditional sized ladders in small-configuration hoistways, a technician cannot tilt or incline the pit ladder to access to the locking mechanism located on the top of ladder to thus control operation (e.g., collapsing and expanding the foldable ladder).

### SUMMARY

According to one embodiment, a foldable ladder for use within a pit of an elevator system is provided. The foldable ladder includes a first upright, a second upright, and a plurality of rungs extending from the first upright to the second upright, wherein each rung is pivotally mounted to each of the first upright and the second upright. A locking mechanism is provided and has a first segment pivotally attached to the first upright and a second segment pivotally attached to the second upright, wherein the first segment and the second segment are pivotally connected. A locking device is located on the first upright and operably connected to the first segment. The locking device includes a first portion comprising a first catch and a second catch, a second portion comprising a pin moveable to engage with the first catch to secure the locking mechanism in a first position and moveable to engage with the second catch to secure the locking mechanism in a second position, a biasing mechanism applying a force to the pin to engage the pin with the first or second catch, and an operating device operable to apply an opposing force against the biasing mechanism to disengage the pin from the first or second catch.

In addition to one or more of the features described above, or as an alternative, further embodiments of the foldable ladder may include that the biasing mechanism is a spring.

In addition to one or more of the features described above, or as an alternative, further embodiments of the foldable ladder may include that when the locking mechanism is in the first position the foldable ladder is in a collapsed position.

In addition to one or more of the features described above, or as an alternative, further embodiments of the foldable ladder may include that when the locking mechanism is in the second position the foldable ladder is in an open position.

In addition to one or more of the features described above, or as an alternative, further embodiments of the foldable ladder may include a remote operating element configured to enable a user to remotely operate the operating device.

In addition to one or more of the features described above, or as an alternative, further embodiments of the foldable ladder may include that the remote operating element is at least one of a rope, a string, a chain, and a rod.

In addition to one or more of the features described above, or as an alternative, further embodiments of the foldable ladder may include that the remote operating element has a length that is at least 30% a length of the foldable ladder.

According to another embodiment, a method of operating a locking mechanism of a foldable ladder for a pit of an elevator system is provided. The foldable ladder including a first upright, a second upright, and a plurality of rungs extending from the first upright to the second upright, wherein each rung is pivotally mounted to each of the first upright and the second upright; a locking mechanism having a first segment pivotally attached to the first upright and a second segment pivotally attached to the second upright, wherein the first segment and the second segment are pivotally connected; and a locking device located on the first upright and operably connected to the first segment, the locking device comprising: a first portion comprising a first catch and a second catch; a second portion comprising a pin moveable to engage with the first catch to secure the locking mechanism in a first position and moveable to engage with the second catch to secure the locking mechanism in a second position; a biasing mechanism applying a force to the pin to engage the pin with the first or second catch; and an operating device operable to apply an opposing force against the biasing mechanism to disengage the pin from the first or second catch. The method is characterized by actuating the operating device to apply a force to the biasing mechanism and transition the pin from the engaged position with the first catch to a disengaged position, transitioning the foldable ladder from a first position to a second position, wherein the locking mechanism is moved from the first position to the second position, and actuating the operating device to transition the pin from the disengaged position into an engaged position with the second catch such that the foldable ladder is secured in the second position.

In addition to one or more of the features described above, or as an alternative, further embodiments of the method may include actuating the operating device to transition the pin from the engaged position with the second catch to the disengaged position, transitioning the foldable ladder from the second position to the first position, and actuating the operating device to transition the pin from the disengaged position into an engaged position with the first catch.

In addition to one or more of the features described above, or as an alternative, further embodiments of the method may include that when the locking mechanism is in the first position the foldable ladder is in a collapsed position.

In addition to one or more of the features described above, or as an alternative, further embodiments of the method may include that when the locking mechanism is in the second position the foldable ladder is in an open position.

In addition to one or more of the features described above, or as an alternative, further embodiments of the method may include a remote operating element configured to enable a user to remotely operate the operating device, wherein actuation of the operating device can be achieved by applying force to the remote operating element.

In addition to one or more of the features described above, or as an alternative, further embodiments of the method may include that the remote operating element is at least one of a rope, a string, a chain, and a rod.

In addition to one or more of the features described above, or as an alternative, further embodiments of the method may include that the remote operating element has a length that is at least 30% a length of the foldable ladder.

Technical effects of embodiments of the present disclosure include a locking mechanism for a foldable ladder that enables operation of the locking mechanism from both the top and bottom of the foldable ladder even while within a small-configuration hoistway.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the disclosure;

FIG. 2A is a schematic illustration of a foldable ladder in accordance with an embodiment of the present disclosure as shown in a first position;

FIG. 2B is a schematic illustration of the foldable ladder of FIG. 2A as shown in a transition or intermediate position;

FIG. 2C is a schematic illustration of the foldable ladder of FIG. 2A as shown in a second position;

FIG. 3A is a schematic illustration of a locking mechanism of a foldable ladder in accordance with an embodiment of the present disclosure as shown in a first position;

FIG. 3B is a schematic illustration of the locking mechanism of FIG. 3A in a transition or intermediate position;

FIG. 3C is a schematic illustration of the locking mechanism of FIG. 3A in a second position;

FIG. 4A is a schematic illustration of a locking device of a locking mechanism in accordance with an embodiment of the present disclosure in a first but unlocked position;

FIG. 4B is a schematic illustration of the locking device of FIG. 4A in a second but unlocked position;

FIG. 5A is a schematic illustration of a second portion of a locking device in accordance with an embodiment of the present disclosure in a disengaged position;

FIG. 5B is a schematic illustration of the second portion of the locking device of FIG. 5A in an engaged position; and

FIG. 6 is a flow process for operating a foldable ladder in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

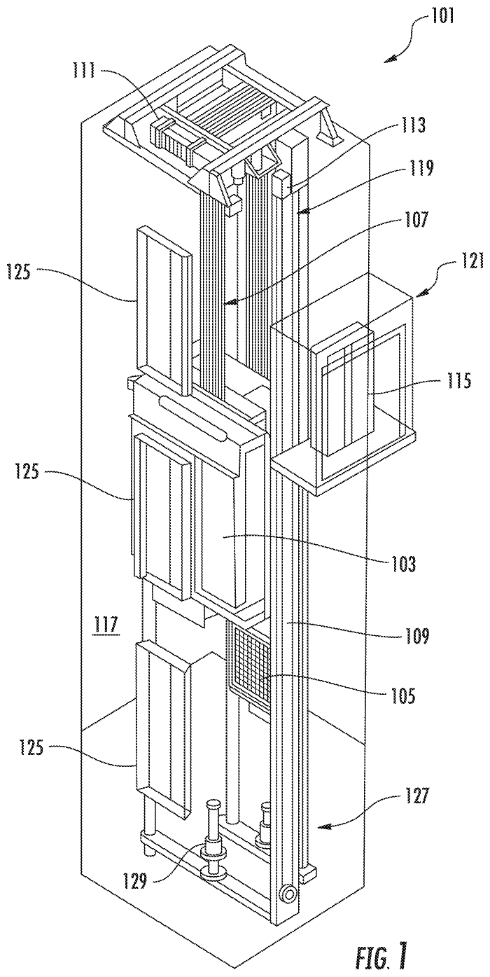

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. At the bottom of the elevator shaft 117, i.e., in pit 127, may be one or more buffers 129 and/or other components of the elevator system 101. The buffers 129 and/or the other components may be secured in the pit 127 of the elevator shaft 117 and at times may require inspection, maintenance, replacement, etc. Accordingly, at times, a technician or other person must gain access to the pit 127 to perform such operations.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

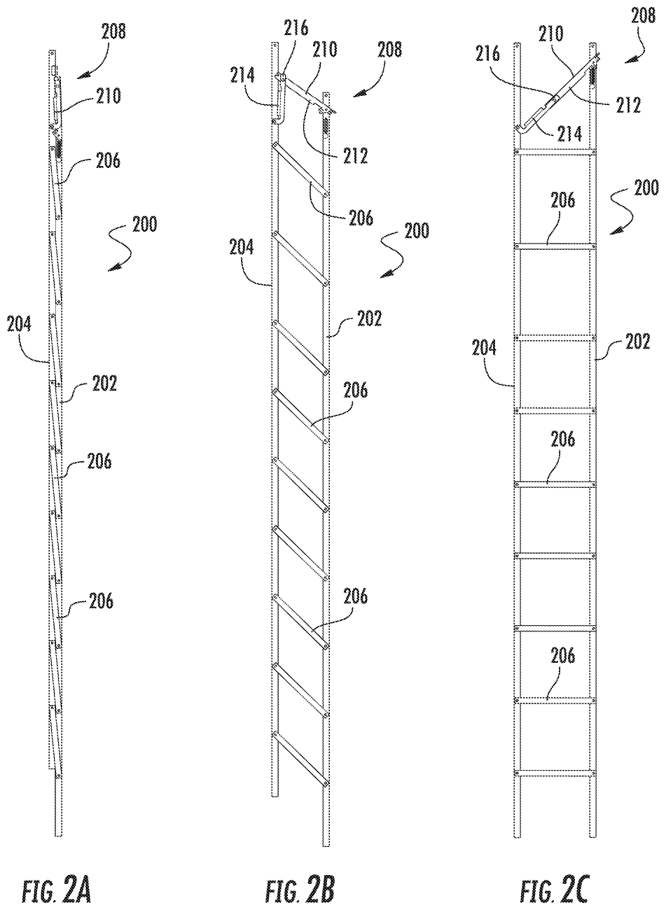

Turning now to FIGS. 2A-2C, schematic illustrations of a foldable ladder 200 that may incorporate embodiments of the present disclosure are shown. FIG. 2A shows the foldable ladder 200 in a first, stowed, or folded position. FIG. 2B shows the foldable ladder 200 in an intermediate position (transitioning from the first position to a second position or vice versa). FIG. 2C shows the foldable ladder 200 in a second, open, or unfolded position.

As shown, the foldable ladder 200 includes a first upright 202, a second upright 204, and a plurality of rungs 206 extending between the first upright 202 and the second upright 204. Each of the rungs 206 is pivotally attached to both the first upright 202 and the second upright 204. Accordingly, when the foldable ladder 200 is transitioned from the first position (FIG. 2A) to the second position (FIG. 2C), the uprights 202, 204 move relative to each other with the rungs 206 rotating or pivoting from almost vertical (in the first position) to horizontal (in the second position).

The foldable ladder 200 includes a locking mechanism 208 that is configured to secure the foldable ladder 200 in one or both of the first position and the second position. The locking mechanism 208, as shown, includes a foldable or hinged arm 210. A first segment 212 of the hinged arm 210 is pivotally connected to the first upright 202 and a second segment 214 of the hinged arm 210 is pivotally connected to the second upright 204. A pivot 216 is located between the first segment 212 and the second segment 214, such that the hinged arm 210 of the locking mechanism 208 can fold/unfold from a first position (FIG. 2A) to a second position (FIG. 2C). In the first position, the foldable ladder 200 has a small profile such that the foldable ladder 200 can be easily transported and also occupy minimal space. In the second position, the foldable ladder 200 can be used by a technician or other person to climb into or out of a pit of an elevator shaft. In accordance with some embodiments, in that position, the foldable ladder shall comply to request code (e.g., minimal width of the ladder's rungs, space between rungs, etc.)

In operation, as the hinged arm 210 is extended from the first position to the second position, the hinged arm 210 extends into an extended, fixed stated. Further, as the foldable ladder 200 is transitioned from the first position to the second position, the rungs 206 rotate, as shown in the transition shown in FIGS. 2A-2C. When fully extended into the second position (FIG. 2C), the hinged arm 210 of the locking mechanism 208 locks and secures the foldable ladder 200 and thus the rungs 206 such that an operator or use can climb the foldable ladder 200 safely. When closing the foldable ladder 200 for storage or for other reason, a user can unlock the hinged arm 210 of the locking mechanism 208 and then fold the foldable ladder 200 in a manner transitioning from the second position (FIG. 2C) to the first position (FIG. 2A). As the segments 212, 214 of the hinged arm 210 pivot about the pivot 216, the rungs 206 rotate into the stowed position shown in FIG. 2A.

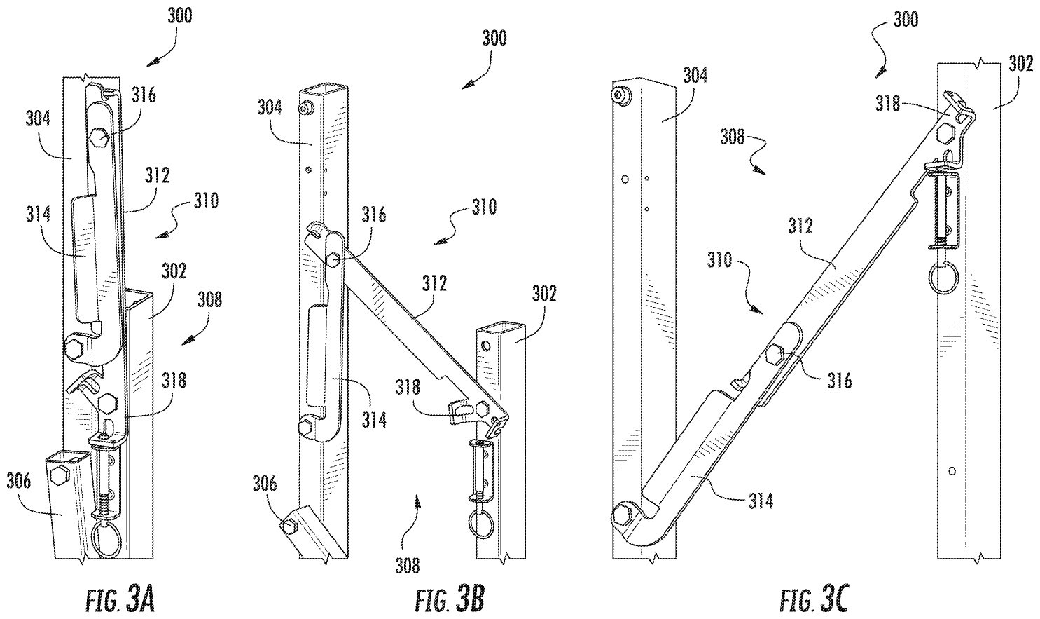

Turning now to FIGS. 3A-3C, schematic illustrations showing the operation of a locking mechanism 308 in accordance with an embodiment of the present disclosure are shown. The operation of the locking mechanism 308 is similar to that shown in FIGS. 2A-2C and is used to enable securing a foldable ladder 300 in a first position (FIG. 3A) and a second position (FIG. 3C) and further enables the foldable ladder 300 to transition from the first position to the second position or vice versa.

As shown, the foldable ladder 300 includes a first upright 302, a second upright 304, and a rung 306 extending from the first upright 302 to the second upright 304. Although only one rung 306 is shown, those of skill in the art will appreciate that any number of rungs 306 can be configured on the foldable ladder 300. As noted above, the rungs 306 are pivotally mounted to the first and second uprights 302, 304 and are unfoldable such that the foldable ladder 300 can be used by a technician or other person to climb up and down the foldable ladder 300 when in the second position.

As shown, the foldable ladder 300 includes the locking mechanism 308 at a top of the foldable ladder 300. However, those of skill in the art will appreciate that the locking mechanism can be located anywhere on the foldable ladder 300 (e.g., top, middle, bottom). The locking mechanism 308 includes a hinged arm 310 having a first segment 312 pivotally attached to the first upright 302 and a second segment 314 pivotally attached to the second upright 304. The first segment 312 and the second segment 314 of the hinged arm 310 are pivotally joined by a pivot 316. As shown in FIGS. 3A-3C, the hinged arm 310 is foldable and/or extendable from a first position (FIG. 3A) to a second position (FIG. 3C). When in the second position, the hinged arm 310 provides a secure, fixed connection between the first upright 302 and the second upright 304 such that the foldable ladder 300 can be used (e.g., climbed) by a technician or other person.

As shown, in addition to being pivotally mounted to the first upright 302, the first segment 312 of the locking mechanism 308 includes a locking device 318 that can include a slot-and-pin configuration, latch-and-lever configuration, or other configuration as known in the art. The locking device 318 is located, in part, on an end of the first segment 312 that is pivotally mounted to the first upright 302. For example, a pin of the locking device 318 can engage with a catch to secure the locking mechanism 318 in a first position (when the foldable ladder 300 is in the first position) or in a second position (when the foldable ladder 300 is in the second position). The catch portion of the locking device 318 can rotate as the first segment of the hinged arm 310 rotates when the folding ladder 300 is moved between the first and second positions.

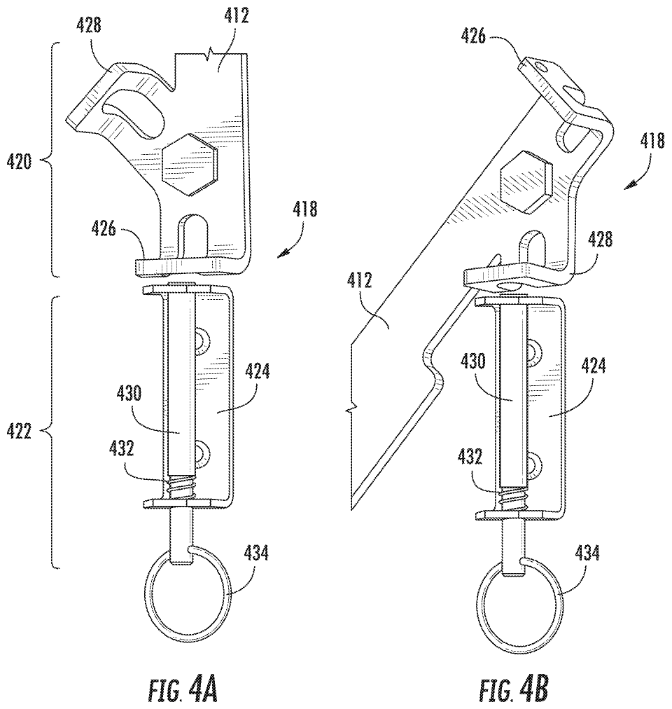

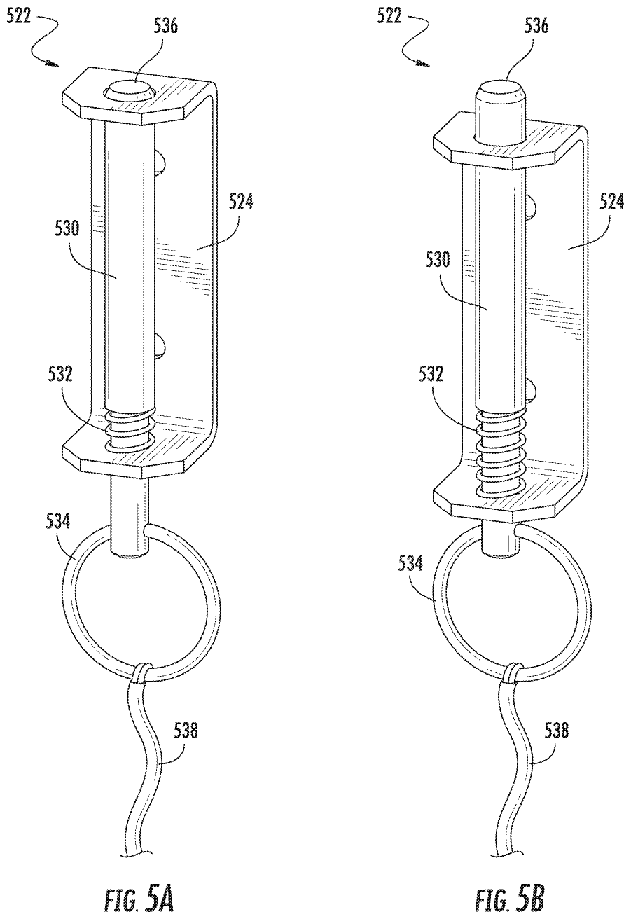

Turning now to FIGS. 4A-4B, a locking device 418 of a locking mechanism of a foldable ladder in accordance with a non-limiting embodiment of the present disclosure is shown. FIG. 4A illustrates the locking device 418 in a first position (but unlocked; see, e.g., FIG. 5B for extended/locked position) and FIG. 4B illustrations the locking device 418 in a second position (but unlocked). The first position of the locking device 418 (FIG. 4A) corresponds to the foldable ladder in the first or collapsed position (e.g., FIG. 2A) and the second position of the locking device 418 (FIG. 4B) corresponds to the foldable ladder in the second or open position (e.g., FIG. 2C). For ease of illustration, an upright of the foldable ladder is not shown, but those of skill in the art will appreciate that the locking device 418 is configured to be mounted and secured to an upright of a foldable ladder (as shown and described above).

The locking device 418 includes a first portion 420 and a second portion 422. The first portion 420 is part of, connected to, and/or integrally formed with the first segment 412 of the hinged arm of the locking mechanism (e.g., as described above). The first portion 420 is pivotally mounted and/or rotatable with respect to the upright of the foldable ladder (not shown). The second portion 422 is fixedly attached to the upright by a bracket 424.

As shown, the first portion 420 is a catch mechanism having a first catch 426 and a second catch 428. The first catch 426 and the second catch 428 are configured to receive a pin 430 that is part of the second portion 422. The pin 430 is supported on the bracket 424 and biased upward and toward the first portion 420 by a biasing mechanism 432 (e.g., a spring). The pin 430 is moveable by operation or force applied by an operating device 434.

In both FIGS. 4A-4B, the operating device 434 is applying a downward force such that the pin 430 is pulled downward and the biasing mechanism 432 is compressed. When the operating device 434 is released or ceases applying force on the pin 430, the biasing mechanism 432 will expand and force the pin 430 upward such that the pin 430 will engage with one of the first catch 426 or the second catch 428. With the pin 430 engaged in a catch 426, 428, the catch 426, 428 is secured or locked in position, and thus the first portion 420 of the locking device 418 cannot rotate, and thus the first segment 412 (and the hinged arm) will be secured. When it is desired to release the first portion 420 from the second portion 422, the operating device 434 can be actuated or otherwise operated to enable the first portion 420 to rotate, and thus have the hinged arm expand or contract (e.g., move between the first position and the second position or vice versa).

Turning now to FIGS. 5A-5B, enlarged illustrations of a second portion 522 of a locking device in accordance with a non-limiting embodiment of the present disclosure are shown. As shown, the second portion 522 in FIG. 5A is in a retracted, release, or disengaged position. In the disengaged position, a tip 536 of a pin 530 is pulled downward by an operating device 534 and a biasing mechanism 532 is compressed. When in the release position (FIG. 5A), the pin 530 is disengaged from a catch of a first portion of a locking device (not shown) and the first portion is free to rotate or move relative to the second portion 522.

However, as shown in FIG. 5B, in an engaged position with the tip 536 of the pin 530 sticking above the bracket 524, the tip 536 of the pin 530 can engage with a catch of the first portion, and thus secure the locking device of a foldable ladder and thus secure the foldable ladder in a first position or a second position. As shown in FIG. 5B, in the engaged position the biasing mechanism 532 is extended, and thus applies an upward force on the pin 530.

As shown and described herein, the locking mechanism includes an operating device that enables locking and unlocking of a locking device, and thus enables the locking mechanism to secure the foldable ladder in a first or second position. As shown, in FIGS. 4A-4B and 5A-5B, the operating device includes a ring that is connected to and/or attached to the pin (e.g., pin 430, 530) of the second portion of the locking device. In some embodiments, a rope, string, chain, rod, or other remote operating element can be connected to the operating device such that the locking device can be operated from some distance away.

For example, as shown in FIGS. 5A-5B, a remote operating element 538 is attached to the operating device 534 such that a user can easily operate the operating device 534 when the user is located at the bottom of the foldable ladder. For example, the remote operating element 538 can be a rope, string, chain, rod, fixed arm, etc. The length of the remote operating element 538 can determined based on the total length of the foldable ladder, and selected such that an operator can easily reach and operate the operating device 534 by pulling on or otherwise operating, actuating, or otherwise using the remote operating element 538. For example, in some embodiments, the remote operating element can be a rod or other structure that is pushed to actuate the operating device. In some embodiments, the remote operating element 538 can be greater than 30% of the length of the foldable ladder to ensure a user can reach the remote operating element 538 and thus easily operate the operating device 534.

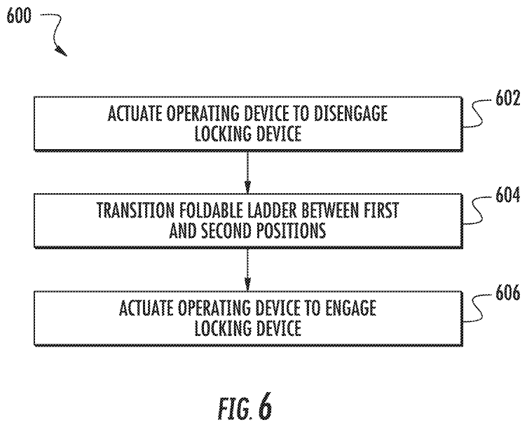

Turning now to FIG. 6, a flow process for operating a foldable ladder in accordance with a non-limiting embodiment of the present disclosure is shown. The flow process 600 can be used to operate a foldable ladder similar to that shown and described above and/or variations thereon. For example, the locking device and/or the operating device/remote operating element can be different from that shown and described above.

At block 602, a user can actuate an operating device to disengage a locking device or a portion thereof that is configured on a foldable ladder. The actuation of the operating device can apply a force to a pin that is biased by a biasing mechanism. The pin can thus be removed from engagement with a first catch of a locking device. The actuation can be by pulling on a remote operating element that is operably connected to the operating device of a locking mechanism. With the pin in the disengaged position, a hinged arm of the foldable ladder is able to be extended to open the foldable ladder. That is, with the pin disengaged, a first portion of the locking device is free to be rotated and thus allow the foldable ladder to be opened.

Accordingly, at block 604, the foldable ladder is transitioned from a first position (e.g., folded) to a second position (e.g., open). The opening of the ladder can be achieved by moving a first upright of the foldable ladder away from a second upright of the foldable ladder. During this operation, a plurality of rungs of the foldable ladder may rotate or pivot to form the steps of the ladder.

With the foldable ladder in the second position, the operating device can be actuated again to engage the locking device with a second catch of the locking device. In some embodiments, the second actuation may be release of the operating device such that the biasing mechanism can return to an extended position wherein the pin is urged into engagement with the second catch. Accordingly, the foldable ladder can be opened and secured in the open position. Further, in some embodiments, the operating device can remain actuated (e.g., pulled downward) during the transition of the foldable ladder from the first position to the second position or vice versa. Accordingly, in some embodiments, repeated actuation may not be necessary as will be appreciated by those of skill in the art. Further, in some embodiments having a biased pin or other configuration, the operating device may be required to be actuated just prior to securing the locking device or catch into a secured position (e.g., to enable the catch to pass over the pin).

Those of skill in the art will appreciate that the ladder can be closed into and/or secured in a stowed position by repeating flow process 600, but at step 604 the foldable ladder is transitioned from the second position to the first position. The actuation of the operating device is the same as described above.

Accordingly, foldable ladders as provided herein can easily be operated by a user from either the top or the bottom of the ladder. Advantageously, such mechanisms as provided herein enable a user to collapse or fold the foldable ladder when within a pit of an elevator shaft, and thus minimize the amount of space occupied by the foldable ladder within the pit of the elevator shaft. Then, when the user needs to climb the ladder (e.g., to get out of the pit), the user can pull on the rope or other element and operate the operating device of the locking mechanism, and thus deploy the ladder to enable the user to climb the foldable ladder. Further, as noted above, the locking mechanisms as provided herein enable a secure lock such that the foldable ladder is secured in one of the first position or the second position.

Advantageously, embodiments described herein provide a foldable ladder that easily operated (folded and unfolded) from both the top and the bottom of the ladder. Further, embodiments provided here enable operation of a locking mechanism of a foldable ladder regardless of the length of the ladder.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A foldable ladder for use within a pit of an elevator system, the foldable ladder comprising:
a first upright, a second upright, and a plurality of rungs extending from the first upright to the second upright, wherein each rung is pivotally mounted to each of the first upright and the second upright;
a locking mechanism having a first segment pivotally attached to the first upright and a second segment pivotally attached to the second upright, wherein the first segment and the second segment are pivotally connected; and
a locking device located on the first upright and operably connected to the first segment, the locking device comprising:
a first portion comprising a first catch and a second catch;
a second portion comprising a pin moveable to engage with the first catch to secure the locking mechanism in a first position and moveable to engage with the second catch to secure the locking mechanism in a second position;
a biasing mechanism applying a force to the pin to engage the pin with the first or second catch; and
an operating device operable to apply an opposing force against the biasing mechanism to disengage the pin from the first or second catch.

2. The foldable ladder of claim 1, wherein the biasing mechanism is a spring.

3. The foldable ladder of claim 1, wherein when the locking mechanism is in the first position the foldable ladder is in a collapsed position.

4. The foldable ladder of claim 1, wherein when the locking mechanism is in the second position the foldable ladder is in an open position.

5. The foldable ladder of claim 1, further comprising a remote operating element configured to enable a user to remotely operate the operating device.

6. The foldable ladder of claim 5, wherein the remote operating element is at least one of a rope, a string, a chain, and a rod.

7. The foldable ladder of claim 5, wherein the remote operating element has a length that is at least 30% a length of the foldable ladder.

8. A method of operating a locking mechanism of a foldable ladder for a pit of an elevator system, the foldable ladder including a first upright, a second upright, and a plurality of rungs extending from the first upright to the second upright, wherein each rung is pivotally mounted to each of the first upright and the second upright; a locking mechanism having a first segment pivotally attached to the first upright and a second segment pivotally attached to the second upright, wherein the first segment and the second segment are pivotally connected;
and a locking device located on the first upright and operably connected to the first segment, the locking device comprising: a first portion comprising a first catch and a second catch; a second portion comprising a pin moveable to engage with the first catch to secure the locking mechanism in a first position and moveable to engage with the second catch to secure the locking mechanism in a second position; a biasing mechanism applying a force to the pin to engage the pin with the first or second catch; and an operating device operable to apply an opposing force against the biasing mechanism to disengage the pin from the first or second catch, the method characterized by:
actuating the operating device to apply a force to the biasing mechanism and transition the pin from the engaged position with the first catch to a disengaged position;
transitioning the foldable ladder from a first position to a second position, wherein the locking mechanism is moved from the first position to the second position; and
actuating the operating device to transition the pin from the disengaged position into an engaged position with the second catch such that the foldable ladder is secured in the second position.

9. The method of claim 8, further comprising:
actuating the operating device to transition the pin from the engaged position with the second catch to the disengaged position;
transitioning the foldable ladder from the second position to the first position; and
actuating the operating device to transition the pin from the disengaged position into an engaged position with the first catch.

10. The method of claim 8, wherein when the locking mechanism is in the first position the foldable ladder is in a collapsed position.

11. The method of claim 8, wherein when the locking mechanism is in the second position the foldable ladder is in an open position.

12. The method of claim 8, further comprising a remote operating element configured to enable a user to remotely operate the operating device, wherein actuation of the operating device can be achieved by applying force to the remote operating element.

13. The method of claim 12, wherein the remote operating element is at least one of a rope, a string, a chain, and a rod.

14. The method of claim 12, wherein the remote operating element has a length that is at least 30% a length of the foldable ladder.
